(19) United States
(12) Patent Application Publication
(10) Pub. No.: US 2016/0357263 A1
(43) Pub. Date: Dec. 8, 2016

(54) HAND-GESTURE-BASED INTERFACE UTILIZING AUGMENTED REALITY

(71) Applicant: Augumenta Ltd, Oulu (FI)

(72) Inventors: Peter Antoniac, Oulu (FI); Damien Douxchamps, Kyoto (JP); Tero Aaltonen, Taipei (TW)

(21) Appl. No.: 14/804,593

(22) Filed: Jul. 21, 2015

Related U.S. Application Data
(60) Provisional application No. 62/027,485, filed on Jul. 22, 2014.

(51) Int. Cl. G06F 3/01; G02B 27/01; G06K 9/00

(52) U.S. Cl. CPC G06F 3/017; G06K 9/00355; G02B 27/0172; G02B 2027/0141; G02B 2027/0138; G02B 2027/0178; G02B 2027/014

(57) ABSTRACT

A system for providing a hand-gesture-based human-to-device interface includes an imaging device configured to record a sequence of still images and a computing device coupled in communication with the imaging device. The computing device includes a processor and a memory coupled to the processor, wherein the processor is configured to analyse the sequence of still images to identify at least one hand gesture made by a user, determine whether or not the at least one hand gesture includes at least one predefined hand gesture, identify an output signal corresponding to the at least one hand gesture, when the at least one hand gesture includes at least one predefined hand gesture, and use the output signal to control a quantity of at least one analogue parameter.

### TECHNICAL FIELD

The present disclosure relates generally to augmented reality; and more specifically, to systems for providing a hand-gesture-based human-to-device interface by utilizing augmented reality, for example, for use in smart glasses, head-mounted displays, near-eye displays and the like. Moreover, the present disclosure relates to methods for providing a hand-gesture-based human-to-device interface by utilizing augmented reality, for example, for use in smart glasses, head-mounted displays, near-eye displays and the like. Furthermore, the present disclosure also concerns computer program products comprising non-transitory machine-readable data storage media having stored thereon program instructions that, when accessed by a processing device, cause the processing device to execute the aforesaid methods.

### BACKGROUND

In past few decades, there has been a drastic change in the field of communication devices and technology associated with them. As an example, earlier communication devices, which were prevalent few decades ago, were wired telephones, telegrams, pagers and the like. However, nowadays, most people use communication devices, for example, such as mobile devices, personal computers, laptops, smart telephones, smart glasses, head-mounted displays, near-eye displays and the like. The term “smart glass” generally refers to a head-mounted device that includes a display. Some smart glasses include a camera pointing away from a user's face and computing hardware for analysing images captured by the camera to provide information to the user.

The communication devices can be controlled via various advanced technologies. One such technique to control a communication device is via a use of gesture recognition.

Gesture recognition enables humans to communicate with communication devices naturally. Gesture recognition typically corresponds to hand gesture recognition, facial gesture recognition, sign language recognition and the like.

Hand gestures are a natural way to communicate. In fact, some types of information can be passed via hand gestures in a fast and simple manner. As an example, major auction houses use hand gestures for bidding on multi-million auctions. As another example, military air marshals use hand and body gestures to direct flight operations aboard aircraft carriers.

Moreover, hand gesture recognition technologies enable operations of complex machines to be performed using only a series of hand and finger movements. This eliminates a need for a physical contact between an operator and a machine.

Furthermore, using the hand gesture recognition technologies, it is now possible to point a finger to move a pointer object on a display accordingly. The display may, for example, be rendered on a smart glass or a display screen or be projected on an environment.

Some conventional hand gesture recognition systems use stereo-vision and/or infrared light to control and/or interact with communication devices. Some conventional hand gesture recognition systems use textured light, while some other conventional hand gesture recognition systems use Time-of-Flight (ToF) cameras. Although these conventional systems provide a powerful recognition, they consume a large amount of energy and are quite expensive.

Moreover, some conventional systems use special sensors that are required to be worn by a user for capturing movements and translating the movements into commands. These systems are complex to set up and are expensive in terms of a cost of materials used as well as an amount of energy consumed.

Furthermore, some conventional systems use motion vectors for video image and base separation on detected vectors. However, these systems fail when a user wears a camera on his/her body.

Moreover, most of the abovementioned systems do not efficiently incorporate environmental variations, for example, such as an exposure, an intensity of light, a background colour, a back-light, hands of different users, a colour of skin, gloves worn by a user and the like, while controlling communication devices.

### SUMMARY

The present disclosure seeks to provide an improved system for providing a hand-gesture-based human-to-device interface, for example, for use in smart glasses, Head-Mounted Displays (HMD's), Near-Eye Displays (NED's) and the like.

The present disclosure also seeks to provide an improved method for providing a hand-gesture-based human-to-device interface, for example, for use in smart glasses, HMD's, NED's and the like.

A further aim of the present disclosure is to at least partially overcome at least some of the problems of the prior art, as discussed above.

In a first aspect, embodiments of the present disclosure provide a system for providing a hand-gesture-based human-to-device interface, the system comprising:

an imaging device configured to record a sequence of still images; and
a computing device coupled in communication with the imaging device, wherein the computing device comprises:
a processor; and
a memory coupled to the processor,
wherein the processor is configured to:
(a) analyse the sequence of still images to identify at least one hand gesture made by a user;
(b) determine whether or not the at least one hand gesture includes at least one predefined hand gesture;
(c) identify an output signal corresponding to the at least one hand gesture, when the at least one hand gesture includes at least one predefined hand gesture; and
(d) use the output signal to control a quantity of at least one analogue parameter.

In embodiments of the present disclosure, the term “hand gesture” generally refers to a gesture that the user makes using his/her hands and/or fingers. The gesture can either be a still gesture in which the user's hands and/or fingers are in a particular pose without any substantial movement or be a motion gesture in which the user's hands and/or fingers move in a particular manner.

In a second aspect, embodiments of the present disclosure provide a method for providing a hand-gesture-based human-to-device interface, the method comprising:

recording a sequence of still images;
analysing the sequence of still images to identify at least one hand gesture made by a user;
determining whether or not the at least one hand gesture includes at least one predefined hand gesture;
identifying an output signal corresponding to the at least one hand gesture, when the at least one hand gesture includes at least one predefined hand gesture; and
using the output signal to control a quantity of at least one analogue parameter.

In a third aspect, embodiments of the present disclosure provide a computer program product comprising a non-transitory machine-readable data storage medium having stored thereon program instructions that, when accessed by a processing device, cause the processing device to:

analyse a sequence of still images to identify at least one hand gesture made by a user;
determine whether or not the at least one hand gesture includes at least one predefined hand gesture;
identify an output signal corresponding to the at least one hand gesture, when the at least one hand gesture includes at least one predefined hand gesture; and
use the output signal to control a quantity of at least one analogue parameter.

Embodiments of the present disclosure substantially eliminate or at least partially address the aforementioned problems in the prior art, and enable users to control analogue parameters with ease, and facilitate augmented reality, for example, in smart glasses, HMD's, NED's and the like.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for providing a hand-gesture-based human-to-device interface, in accordance with an embodiment of the present disclosure;

FIG. 2 is a schematic illustration of a head-mounted device by way of which a system for providing a hand-gesture-based human-to-device interface is implemented, in accordance with an embodiment of the present disclosure

FIG. 3 is a schematic illustration of various components of a computing device, in accordance with an embodiment of the present disclosure;

FIGS. 4A and 4B collectively are an illustration of steps of a method for providing a hand-gesture-based human-to-device interface, in accordance with an embodiment of the present disclosure;

FIG. 5 is a schematic illustration of example gestures, in accordance with an embodiment of the present disclosure;

FIG. 6 is a schematic illustration of an example hand-gesture-based human-to-device interface provided by the system pursuant to embodiments of the present disclosure;

FIG. 7 is a schematic illustration of an example gesture, in accordance with an embodiment of the present disclosure; and

FIG. 8 is a schematic illustration of how a UI element is overlapped or blended over a real view of a hand of a user, in accordance with an embodiment of the present disclosure.

In the accompanying drawings, an underlined number is employed to represent an item over which the underlined number is positioned or an item to which the underlined number is adjacent. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

### GLOSSARY

Brief definitions of terms used throughout the present disclosure are given below.

The term “hand gesture” generally refers to a gesture that a user makes using his/her hands and/or fingers. The gesture can either be a still gesture in which the user's hands and/or fingers are in a particular pose without any substantial movement or be a motion gesture in which the user's hands and/or fingers move in a particular manner. Examples of still gestures include, but are not limited to, a closed first of the user, an open palm of the user, a thumbs-up gesture of the user and a thumbs-down gesture of the user. Examples of motion gestures include, but are not limited to, a waving gesture, a sliding gesture and a swiping gesture.

The term “activation gesture” generally refers to a hand gesture that a user makes to activate a system pursuant to embodiments of the present disclosure. Optionally, an activation gesture is used to wake up a computing device of the system, when the computing device is in a low-power hibernating or sleep mode of operation.

The term “deactivation gesture” generally refers to a hand gesture that the user makes to deactivate the system pursuant to embodiments of the present disclosure. Optionally, a deactivation gesture is used to put the computing device to sleep or hibernate, for example, after the user has performed desired actions.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based upon the present disclosure provided herein, one of ordinary skill in the art will appreciate a variety of ways in which connection or coupling exists in accordance with the aforementioned definition.

The terms “first”, “second”, and the like, herein do not denote any order, quantity, or importance, but rather are used to distinguish one element from another. Furthermore, the terms “a” and “an” herein do not denote a limitation of quantity, but rather denote the presence of at least one of the referenced item.

The phrases “in an embodiment”, “in accordance with an embodiment” and the like generally mean the particular feature, structure, or characteristic following the phrase is included in at least one embodiment of the present disclosure, and may be included in more than one embodiment of the present disclosure Importantly, such phrases do not necessarily refer to the same embodiment.

If the specification states a component or feature “may”, “can”, “could”, or “might” be included or have a characteristic, that particular component or feature is not required to be included or have the characteristic.

### EMBODIMENTS OF THE PRESENT DISCLOSURE

In a first aspect, embodiments of the present disclosure provide a system for providing a hand-gesture-based human-to-device interface, the system comprising:

an imaging device configured to record a sequence of still images; and
a computing device coupled in communication with the imaging device, wherein the computing device comprises:
a processor; and
a memory coupled to the processor,
wherein the processor is configured to:
(a) analyse the sequence of still images to identify at least one hand gesture made by a user;
(b) determine whether or not the at least one hand gesture includes at least one predefined hand gesture;
(c) identify an output signal corresponding to the at least one hand gesture, when the at least one hand gesture includes at least one predefined hand gesture; and
(d) use the output signal to control a quantity of at least one analogue parameter.

For the sake of clarity, the term “sequence of still images” is used to refer to still images, movies and/or videos that are recorded by the imaging device, without departing from the scope of the present disclosure. It is to be noted that in some situations, the sequence of still images may realise as a single image.

Moreover, optionally, the sequence of still images includes real-time images.

According to an embodiment of the present disclosure, the imaging device is operable to record the sequence of still images using frequencies other than visible light. In one example, the imaging device is operable to record the sequence of still images using Infra-Red (IR) radiation. In another example, the imaging device is operable to record the sequence of still images using modulated light. In this example, the imaging device is operable to sense a depth of an object whose image is being recorded.

It will be appreciated that the system is not limited to a specific number or type of imaging devices. In other words, the system can include more than one imaging device. In one example implementation, the system includes two imaging devices. In this implementation, the computing device optionally employs triangulation to determine a distance of the user's hand from the imaging devices, from knowledge of angles of view of the imaging devices, a location of the user's hand in images recorded by the imaging devices and a distance between the imaging devices.

Examples of the imaging device include, but are not limited to, a still camera, a video camera, a phone camera, a digital camera, a web camera, an Internet Protocol (IP) camera, a stereoscopic camera, a Light Detection And Ranging (LiDAR) camera, and an IR camera.

Examples of the computing device include, but are not limited to, mobile communication devices, head-mounted devices, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized screens with embedded PCs, and other interactive devices, such as Television (TV) sets and Set-Top Boxes (STBs).

The aforementioned system is particularly suitable for use with smart glasses, Optical Head-Mounted Displays (OHMD's), video see-though Head-Mounted Displays (HMD's), Near-Eye Displays (NED's), retinal projectors, retinal implants and the like.

According to an embodiment of the present disclosure, when identifying the at least one hand gesture at (a), the processor is configured to perform at least one of:

(i) detect at least one object in the sequence of still images;
(ii) detect a background in the sequence of still images;
(iii) separate the at least one object from the background;
(iv) extract, from the separated object, information indicative of at least one of: a colour of the separated object in a given image, a depth of the separated object in the given image, an angle of the separated object in the given image, a pose of the separated object in the given image, a location of the separated object in the given image, a shape of the separated object in the given image, and/or a size of the separated object in the given image; and
(v) use the extracted information to identify the at least one hand gesture.

Optionally, when detecting the at least one object at (i) and/or separating the at least one object from the background at (iii), the processor is configured to employ at least one feature detection technique. The at least one feature detection technique corresponds to at least one of: motion vectors, edge detection, corner detection, shape detection, colour detection, contour detection, and/or texture detection. As an example, the processor can employ an adaptive real-time skin detector algorithm based upon hue thresholding. As another example, the processor can employ an algorithm based upon Principal Component Analysis (PCA) based colour segmentation. As yet another example, the processor can employ an algorithm based upon pattern recognition, for example, such as neural networks and deep learning. As still another example, the processor can employ a local feature detector, for example, such as Scale-Invariant Feature Transform (SIFT), Speeded Up Robust Features (SURF) and the like.

Alternatively, optionally, when detecting at (i), the processor is configured to employ a cascaded and/or boosted detector. Likewise, optionally, when separating at (iii), the processor is configured to employ a cascaded and/or boosted classifier.

Yet alternatively, optionally, when detecting at (i) and/or separating at (iii), the processor is configured to employ a three-dimensional (3-D) stereoscopic depth measuring technique. Still alternatively, optionally, when detecting at (i) and/or separating at (iii), the processor is configured to employ a Time-of-Flight (ToF) depth measuring technique, for example, such as LiDAR.

In some implementations, the user's hands are covered with gloves. This potentially enables the computing device to detect the at least one object, namely the gloves, at (i), based upon a colour and/or a texture of the gloves, and to identify the at least one hand gesture from the information extracted at (iv).

Optionally, when identifying the at least one hand gesture at (v), the processor is configured to analyse the extracted information for the sequence of still images to identify a direction of motion of the separated object, namely the user's hands and/or fingers. Optionally, in this regard, the processor is configured to identify hand gestures performed in two or three dimensions. As an example, the processor can identify a hand gesture in which the user's hand makes a circle, a triangle and the like. As another example, the processor can identify a hand gesture in which the user's hand is moving towards or away from the imaging device.

Moreover, according to an embodiment of the present disclosure, the computing device includes a data storage for storing a plurality of predefined hand gestures and their corresponding output signals. An example of such a data storage is a database.

The plurality of predefined hand gestures can be either user-defined or system-defined by default.

According to an embodiment of the present disclosure, the processor is configured to define the plurality of predefined hand gestures. Optionally, in this regard, the processor is configured to associate each hand gesture with its corresponding output signal.

It will be appreciated that the number of simple hand gestures is limited. Therefore, optionally, the processor is configured to define mutually different combinations and/or sequences of simple hand gestures as mutually different hand gestures. Optionally, such combinations and/or sequences of simple hand gestures are performed within a predefined time period. The predefined time period can be either user-defined or system-defined by default.

This potentially enables the user to define new hand gestures with the computing device. Optionally, the new hand gestures are defined using macros.

Moreover, optionally, when determining at (b), the processor is configured to lookup for the at least one hand gesture in the plurality of predefined hand gestures stored in its data storage. Optionally, in this regard, the processor is configured to determine that the at least one hand gesture includes at least one predefined hand gesture when the at least one hand gesture matches with the at least one predefined hand gesture. More optionally, the processor is configured to extract features from the at least one hand gesture, and match the extracted features with already known features of the at least one predefined hand gesture.

Furthermore, according to an embodiment of the present disclosure, the processor is configured to switch between a low-power hibernating or sleep mode of operation and a full-power mode of operation in response to an action triggered by the output signal. The low-power hibernating or sleep mode of operation beneficially consumes less power relative to the full-power mode of operation of the computing device.

According to an embodiment of the present disclosure, when the at least one hand gesture includes a predefined activation gesture, the processor is configured to switch from the low-power hibernating or sleep mode of operation to the full-power mode of operation. As a consequence, the processor registers user's hands and allows the user to use the hand-gesture-based human-to-device interface with subsequent gestures. Optionally, in this regard, the processor is configured to extract one or more shapes of the user's hand from the sequence of still images, and to compare the one or more shapes with one or more reference shapes. Beneficially, the one or more reference shapes are unique and distinguishable.

Moreover, according to an embodiment of the present disclosure, when the at least one hand gesture includes a predefined deactivation gesture, the processor is configured to switch from the full-power mode of operation to the low-power hibernating or sleep mode of operation.

In one example implementation, the predefined activation gesture is made when the user places an open palm of one of his/her hands or brings the open palm closer to the imaging device. In this implementation, the user makes subsequent gestures using a finger of the other hand of the user. As an example, the subsequent gestures can be made by sliding the finger of the other hand over the open palm, and keeping the finger stable on a desired spot for a predefined time to provide a confirmation. Moreover, in this implementation, the predefined deactivation gesture is made when the user takes off the finger of the other hand.

In another example implementation, the predefined activation gesture is made when the user places his/her fists in a manner that the fists touch each other. In this implementation, the user makes subsequent gestures by pulling the fists apart and keeping the fists stable at a desired distance from each other for a predefined time to provide a confirmation. As an example, such subsequent gestures can be used to control a level of zoom when viewing an image. Moreover, in this implementation, the predefined deactivation gesture is made when the user takes off at least one of his/her fists.

In yet another example implementation, the predefined activation gesture is a thumbs-up gesture, while the predefined deactivation gesture is a thumbs-down gesture.

Furthermore, according to an embodiment of the present disclosure, the at least one analogue parameter is related to the computing device itself. According to another embodiment of the present disclosure, the at least one analogue parameter is related to a remote device; in this embodiment, the quantity of the at least one analogue parameter is remotely communicated to the remote device.

Examples of such analogue parameters include, but are not limited to, a volume of sound of a television, a direction of movement of a robot, an intensity of light emitted by a light source, a speed of a fan, a temperature of a heating or cooling appliance, a direction of movement of a pointer object, a brightness of a display, a zooming-in or zooming-out of an image, a cropping of an image, and a steering of a vehicle. It will be appreciated that the output signal can be used in such a manner in cases where a number input will not be quick and flexible enough.

Moreover, optionally, when controlling the quantity of the at least one analogue parameter at (d), the processor is configured to set the quantity of the at least one analogue parameter to a discrete value from amongst a plurality of discrete values available for the at least one analogue parameter. As an example, in a case where the at least one analogue parameter is a volume of sound, the volume of sound can be set at discrete values, for example, ranging from ‘0’ (zero) to ‘100’.

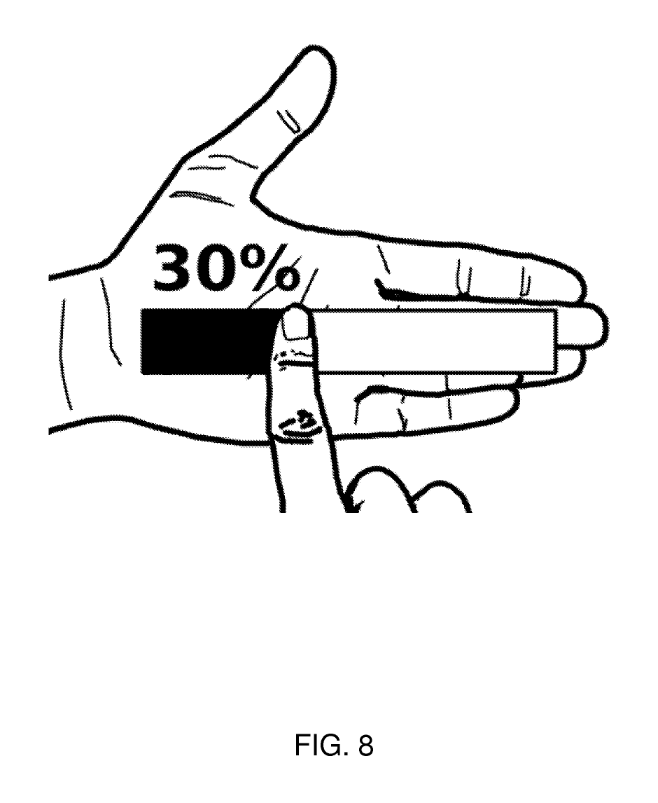

Moreover, optionally, when controlling the quantity of the at least one analogue parameter at (d), the processor is configured to display a user interface (UI) element representing a quantity control on a feedback device in a manner that the UI element overlaps or blends over a view of a hand of the user. This enables the processor to facilitate Augmented Reality (AR). This potentially allows the user to control the UI element with ease. As an example, a virtual slider, a seek bar, a knob or a progress bar can be overlaid on an OHMD or a video see-through HMD, as will be elucidated later in conjunction with FIG. 8.

Additionally or alternatively, optionally, when controlling the quantity of the at least one analogue parameter at (d), the processor is configured to render on the feedback device a value of the quantity of the at least one analogue parameter. Optionally, in this regard, the processor is configured to render the value of the quantity in real time, namely as the quantity is being changed. As an example, a numerical value of the quantity can be displayed on the feedback device. As another example, the change in the quantity can be notified by increasing an intensity of vibration of a haptic output.

Optionally, in this regard, the system includes a feedback device, in addition to the imaging device and the computing device. The computing device is coupled in communication with the feedback device.

According to an embodiment of the present disclosure, the feedback device includes a data storage for storing instructions and/or information pertaining to a plurality of output signals. An example of such a data storage is a database. Optionally, such instructions and/or information are indicative of actions to be performed by the feedback device corresponding to the plurality of output signals.

According to an embodiment of the present disclosure, the feedback device is configured to receive the output signal from the computing device, and to process the output signal to provide a feedback to the user. The feedback can be in a form of a visual feedback, an audio feedback, a haptic feedback, or a combination thereof.

Optionally, the feedback is provided to the user prior to controlling the quantity of the at least one analogue parameter.

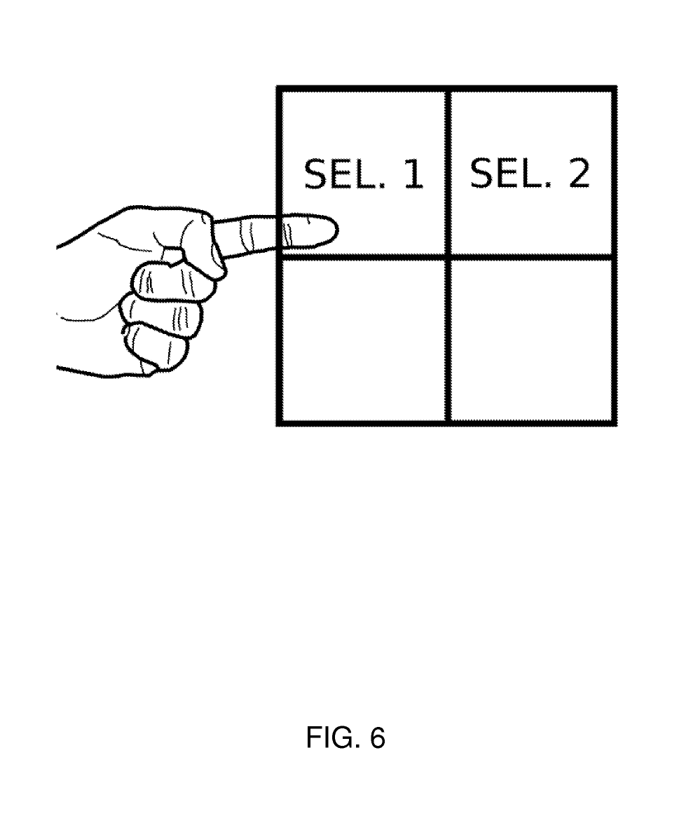

Moreover, according to an embodiment of the present disclosure, the processor is configured to render on the feedback device a plurality of user-selectable objects corresponding to a plurality of mutually different analogue parameters, and to detect a user's selection of the at least one analogue parameter to be controlled. As an example, the plurality of user-selectable objects may correspond to different input options of an audio amplifier, for example, such as “TAPE”, “CD”, “TUNER”, and the like. An example of how the user-selectable objects can be rendered and selected has been illustrated in conjunction with FIG. 6 as explained in more detail below.

Optionally, the user-selectable objects are in a form of icons. Optionally, the user selects a particular icon by making a predefined hand gesture over or under that particular icon. In one example implementation, the predefined hand gesture can be a hovering gesture, wherein the user makes the hovering gesture by stopping a finger over or under that particular icon for a predefined time period. In another example implementation, the predefined hand gesture can be a grabbing gesture, wherein the user makes the grabbing gesture by positioning his/her open hand over or under the particular icon, and then closing his/her first so as to grab that particular icon.

Optionally, the user-selectable objects are in a form of switches. Optionally, the user switches between “on” and “off” states of a particular switch by making a predefined hand gesture. In one example implementation, the predefined hand gesture can be a clicking gesture, wherein the user makes the clicking gesture by positioning a finger over or under the particular switch and moving the finger towards or away from the imaging device to click on that particular switch.

Moreover, optionally, the feedback device renders or projects a visual feedback on a flat surface.

According to an embodiment of the present disclosure, the feedback device is implemented by way of a see-through display. Optionally, in this regard, the feedback device is used for facilitating Augmented Reality (AR). The term “see-through display” generally refers to an electronic display that allows users to see what is shown on a transparent or semi-transparent screen, for example, such as a glass screen, while still being able to see through it.

Optionally, the feedback device is associated with a wearable technology, for example, such as a smart glass, an OHMD, a video see-through HMD, an NED, a retinal projector and the like. An example of the OHMD is Google Glass; “Google” is a registered trademark. An example of the video see-through HMD is Oculus Rift and Samsung Gear VR; “Oculus” and “Samsung” are registered trademarks.

Other examples of the feedback device include, but are not limited to, projection displays, semi-transparent mirrors, monitors, and touch screens.

In one implementation, the imaging device, the computing device and the feedback device are located on a same physical device.

In another implementation, the computing device and the imaging device are located on a same physical device, while the feedback device is located on a separate physical device. In this implementation, the computing device and the feedback device are communicably coupled together, for example, via a cable, a wireless interface, or a communication network.

In yet another implementation, the computing device and the feedback device are located on a same physical device, while the imaging device is located on a separate physical device. In this implementation, the computing device and the imaging device are communicably coupled together, for example, via a cable, a wireless interface, or a communication network.

In still another implementation, the imaging device and the feedback device are located on a same physical device, while the computing device is located on a separate physical device. In this implementation, the computing device is communicably coupled with the imaging device and the feedback device, for example, via a cable, a wireless interface, or a communication network.

In yet still another implementation, the imaging device, the computing device and the feedback device are located on separate physical devices. In this implementation, the computing device is communicably coupled with the imaging device and the feedback device, for example, via a cable, a wireless interface, or a communication network.

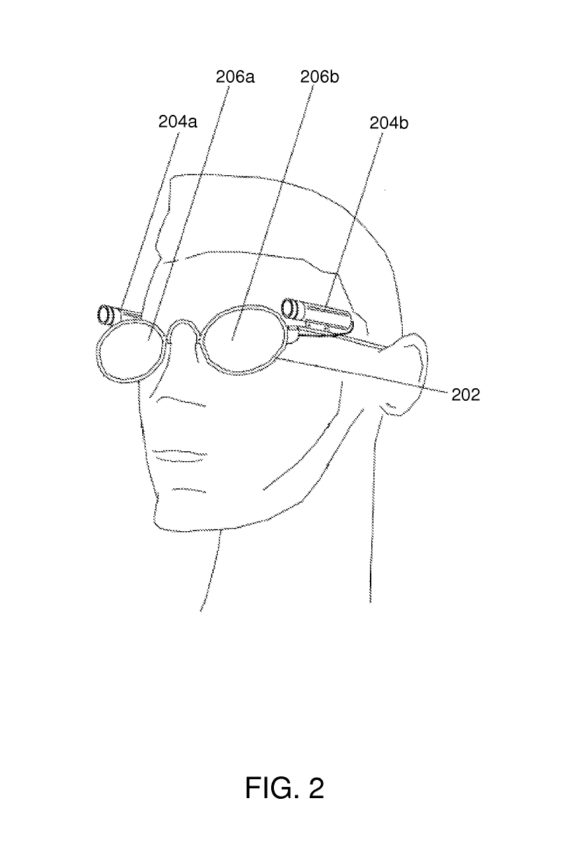

For illustration purposes only, there will now be provided an example in which the aforementioned system is implemented by way of a head-mounted device. One such head-mounted device has been illustrated in conjunction with FIG. 2 as explained in more detail below.

The head-mounted device includes one or more imaging devices. When the head-mounted device is worn by a user, the one or more imaging devices point away from the user's face. Optionally, the imaging devices record a sequence of images of a space in front of the user's face where the user's hands are expected to be present.

It is to be noted here that the head-mounted device can have any number of imaging devices. In one implementation, the head-mounted device has two imaging devices. In another implementation, the head-mounted device has a single imaging device.

Moreover, the head-mounted device also includes a feedback device that is implemented by way of a see-through display. The see-through display includes one or more transparent or semi-transparent screens. Each of the one or more screens has a reflective surface facing the user that is used to reflect an image of a UI element towards the user's eyes in a manner that the UI element overlaps or blends over a real view of the user's hand. In this manner, the head-mounted device facilitates augmented reality.

It will be appreciated that in an alternative implementation, the feedback device can be implemented by way of a retinal projector.

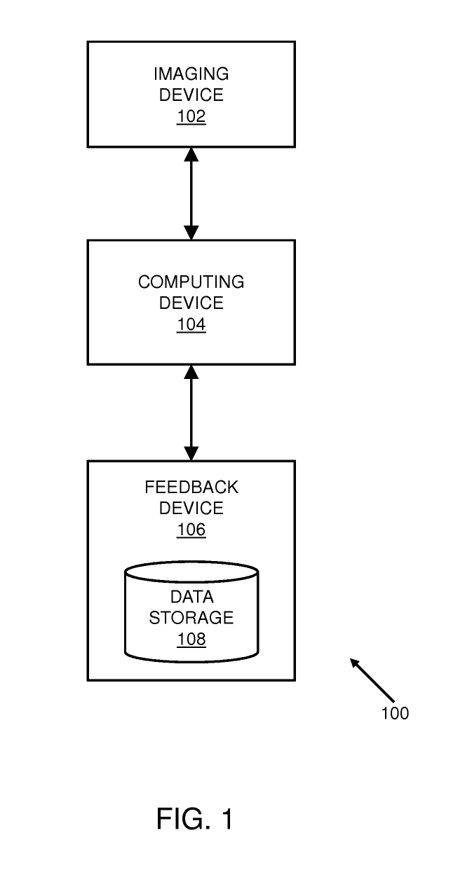

Furthermore, an example system for providing a hand-gesture-based human-to-device interface pursuant to embodiments of the present disclosure has been illustrated in conjunction with FIG. 1 as explained in more detail below. The system includes an imaging device, a computing device and a feedback device. The computing device is coupled in communication with the imaging device and the feedback device.

Optionally, the feedback device includes a data storage for storing instructions and/or information pertaining to a plurality of output signals. An example of such a data storage is a database. Optionally, such instructions and/or information are indicative of actions to be performed by the feedback device corresponding to the plurality of output signals.

When a user moves his/her hands and/or fingers to make a hand gesture, the imaging device records a sequence of still images of the hand gesture made by the user. The imaging device then sends the recorded sequence of still images to the computing device.

Subsequently, the computing device, namely a processor included within the computing device, performs operations as described with respect to the aforementioned first aspect.

Optionally, in this regard, the computing device analyses the recorded sequence of still images to identify the hand gesture made by the user. If the identified hand gesture is a predefined hand gesture, the computing device identifies an output signal corresponding to the predefined hand gesture. Optionally, the computing device then sends the output signal to the feedback device.

Optionally, the feedback device processes the output signal to provide a feedback to the user.

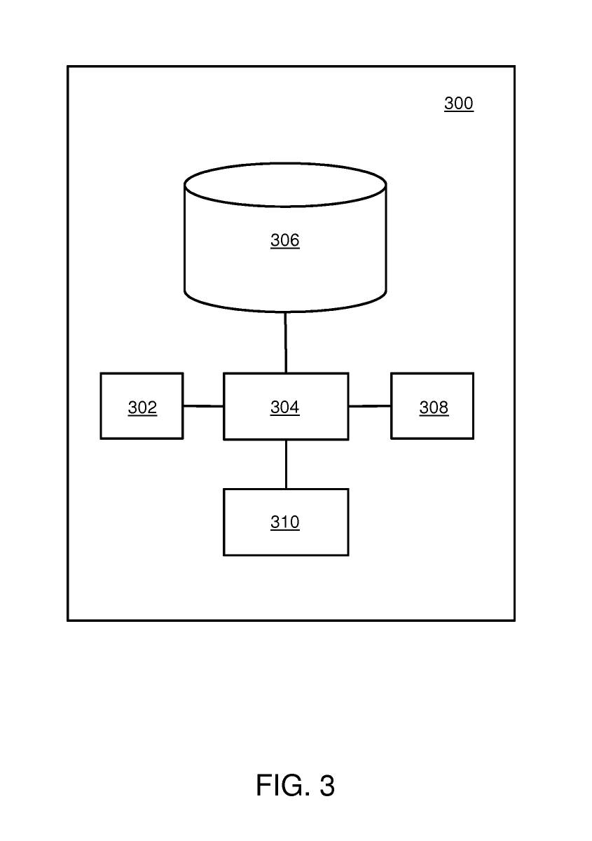

Furthermore, an example of the computing device has been provided in conjunction with FIG. 3 as explained in more detail below. The computing device includes, but is not limited to, a memory, a computing hardware such as a processor, a data storage, a communication interface, and a power source.

The power source supplies electrical power to various components of the computing device. The power source may, for example, include a rechargeable battery.

Optionally, the data storage is a non-transient data storage, for example such as a database. Optionally, the data storage stores a plurality of predefined hand gestures and their corresponding output signals.

The memory optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

The memory stores a software application that includes program instructions pursuant to embodiments of the present disclosure, while the processor is operable to execute the software application.

In one implementation, the software application is a part of an operating system platform of the computing device. In this implementation, the software application is linked and compiled as a part of other software applications running on the computing device.

In another implementation, the software application is a standalone product. In yet another implementation, the software application is a library component that enables software developers to include gesture recognition capabilities in their software applications.

Executing the software application on the processor enables the processor to perform operations as described with respect to the aforementioned first aspect.

Optionally, in this regard, the processor analyses a sequence of still images to identify a hand gesture made by a user, and translates the hand gesture into an output signal when the hand gesture is a predefined gesture from amongst the plurality of predefined hand gestures stored at the data storage.

Optionally, the software application, when executed on the processor, stores new gestures defined by the user and their corresponding output signals at the data storage.

Optionally, the computing device also includes Input/Output (I/O) devices to facilitate an I/O interface between the computing device and other external devices, for example, such as an imaging device and a feedback device. Optionally, the I/O interface is used to receive the sequence of still images from the imaging device. Optionally, the I/O interface is used to send output signals to the feedback device. Optionally, the I/O interface is used to send at least one still image from amongst the sequence of still images to the feedback device, for example, for display to the user and/or for purposes of augmented reality.

Moreover, optionally, the I/O devices include a speaker for providing an audio output to a user, and a microphone for receiving an audio input from the user.

Moreover, optionally, the communication interface allows the computing device to communicate with other devices, for example, such as an imaging device, a feedback device or other remote devices.

Optionally, the communication interface enables the computing device to access services provided by a remote server, for example, via a communication network. Additionally, optionally, the communication interface enables the computing device to download software updates from the remote server.

The communication network can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

In a second aspect, embodiments of the present disclosure provide a method for providing a hand-gesture-based human-to-device interface, the method comprising:

recording a sequence of still images;
analysing the sequence of still images to identify at least one hand gesture made by a user;
determining whether or not the at least one hand gesture includes at least one predefined hand gesture;
identifying an output signal corresponding to the at least one hand gesture, when the at least one hand gesture includes at least one predefined hand gesture; and
using the output signal to control a quantity of at least one analogue parameter.

For the sake of clarity, the term “sequence of still images” is used to refer to still images, movies and/or videos that are recorded by an imaging device, without departing from the scope of the present disclosure. It is to be noted that in some situations, the sequence of still images may realise as a single image.

Moreover, optionally, the sequence of still images includes real-time images.

According to an embodiment of the present disclosure, the method includes recording the sequence of still images using frequencies other than visible light. In one example, the sequence of still images is recorded using IR radiation. In another example, the sequence of still images is recorded using modulated light. In this example, the method includes sensing a depth of an object whose image is being recorded.

Examples of the imaging device include, but are not limited to, a still camera, a video camera, a phone camera, a digital camera, a web camera, an IP camera, a stereoscopic camera, a LiDAR camera, and an IR camera.

According to an embodiment of the present disclosure, when identifying the at least one hand gesture, the method includes at least one of:

(i) detecting at least one object in the sequence of still images;
(ii) detecting a background in the sequence of still images;
(iii) separating the at least one object from the background;
(iv) extracting, from the separated object, information indicative of at least one of: a colour of the separated object in a given image, a depth of the separated object in the given image, an angle of the separated object in the given image, a pose of the separated object in the given image, a location of the separated object in the given image, a shape of the separated object in the given image, and/or a size of the separated object in the given image; and
(v) using the extracted information to identify the at least one hand gesture.

Optionally, when detecting the at least one object at the step (i) and/or separating the at least one object from the background at the step (iii), the method includes employing at least one feature detection technique. The at least one feature detection technique corresponds to at least one of: motion vectors, edge detection, corner detection, shape detection, colour detection, contour detection, and/or texture detection. As an example, the method can employ an adaptive real-time skin detector algorithm based upon hue thresholding. As another example, the method can employ an algorithm based upon PCA-based colour segmentation. As yet another example, the method can employ an algorithm based upon pattern recognition, for example, such as neural networks and deep learning. As still another example, the method can employ a local feature detector, for example, such as SIFT, SURF and the like.

Alternatively, optionally, when detecting at the step (i), the method includes employing a cascaded and/or boosted detector. Likewise, optionally, when separating at the step (iii), the method includes employing a cascaded and/or boosted classifier.

Yet alternatively, optionally, when detecting at the step (i) and/or separating at the step (iii), the method includes employing a 3-D stereoscopic depth measuring technique. Still alternatively, optionally, when detecting at the step (i) and/or separating at the step (iii), the method includes employing a ToF depth measuring technique, for example, such as LiDAR.

In some implementations, the user's hands are covered with gloves. This potentially enables detection of the at least one object, namely the gloves, at the step (i), based upon a colour and/or a texture of the gloves, and subsequent identification of the at least one hand gesture from the information extracted at the step (iv).

Optionally, when identifying the at least one hand gesture at the step (v), the method includes analysing the extracted information for the sequence of still images to identify a direction of motion of the separated object, namely the user's hands and/or fingers. Optionally, in this regard, the method includes identifying hand gestures performed in two or three dimensions. As an example, the method can identify a hand gesture in which the user's hand makes a circle, a triangle and the like. As another example, the method can identify a hand gesture in which the user's hand is moving towards or away from the imaging device.

Moreover, according to an embodiment of the present disclosure, the method includes storing a plurality of predefined hand gestures and their corresponding output signals at a data storage. An example of such a data storage is a database.

The plurality of predefined hand gestures can be either user-defined or system-defined by default.

According to an embodiment of the present disclosure, the method includes defining the plurality of predefined hand gestures. Optionally, in this regard, the method includes associating each hand gesture with its corresponding output signal.

It will be appreciated that the number of simple hand gestures is limited. Therefore, optionally, the method includes defining mutually different combinations and/or sequences of simple hand gestures as mutually different hand gestures. Optionally, such combinations and/or sequences of simple hand gestures are performed within a predefined time period. The predefined time period can be either user-defined or system-defined by default.

This potentially enables the user to define new hand gestures. Optionally, the new hand gestures are defined using macros.

Moreover, optionally, when determining whether or not the at least one hand gesture includes at least one predefined hand gesture, the method includes looking up for the at least one hand gesture in the plurality of predefined hand gestures stored in the data storage. Optionally, in this regard, the method includes determining that the at least one hand gesture includes at least one predefined hand gesture when the at least one hand gesture matches with the at least one predefined hand gesture. More optionally, the method includes extracting features from the at least one hand gesture, and matching the extracted features with already known features of the at least one predefined hand gesture.

Furthermore, according to an embodiment of the present disclosure, the method includes switching between a low-power hibernating or sleep mode of operation and a full-power mode of operation in response to an action triggered by the output signal. The low-power hibernating or sleep mode of operation beneficially consumes less power relative to the full-power mode of operation of the computing device.

According to an embodiment of the present disclosure, when the at least one hand gesture includes a predefined activation gesture, the method includes switching from the low-power hibernating or sleep mode of operation to the full-power mode of operation. As a consequence, the user's hands are registered and the user is allowed to use the hand-gesture-based human-to-device interface with subsequent gestures. Optionally, in this regard, the method includes extracting one or more shapes of the user's hand from the sequence of still images, and comparing the one or more shapes with one or more reference shapes. Beneficially, the one or more reference shapes are unique and distinguishable.

Moreover, according to an embodiment of the present disclosure, when the at least one hand gesture includes a predefined deactivation gesture, the method includes switching from the full-power mode of operation to the low-power hibernating or sleep mode of operation.

In one example implementation, the predefined activation gesture is made when the user places an open palm of one of his/her hands or brings the open palm closer to the imaging device. In this implementation, the user makes subsequent gestures using a finger of the other hand of the user. As an example, the subsequent gestures can be made by sliding the finger of the other hand over the open palm, and keeping the finger stable on a desired spot for a predefined time to provide a confirmation. Moreover, in this implementation, the predefined deactivation gesture is made when the user takes off the finger of the other hand.

In another example implementation, the predefined activation gesture is made when the user places his/her fists in a manner that the fists touch each other. In this implementation, the user makes subsequent gestures by pulling the fists apart and keeping the fists stable at a desired distance from each other for a predefined time to provide a confirmation. As an example, such subsequent gestures can be used to control a level of zoom when viewing an image. Moreover, in this implementation, the predefined deactivation gesture is made when the user takes off at least one of his/her fists.

In yet another example implementation, the predefined activation gesture is a thumbs-up gesture, while the predefined deactivation gesture is a thumbs-down gesture.

Furthermore, according to an embodiment of the present disclosure, the at least one analogue parameter is related to a computing device implementing the aforementioned method at least in part. According to another embodiment of the present disclosure, the at least one analogue parameter is related to a remote device; in this embodiment, the quantity of the at least one analogue parameter is remotely communicated to the remote device.

Examples of such analogue parameters include, but are not limited to, a volume of sound of a television, a direction of movement of a robot, an intensity of light emitted by a light source, a speed of a fan, a temperature of a heating or cooling appliance, a direction of movement of a pointer object, a brightness of a display, a zooming-in or zooming-out of an image, a cropping of an image, and a steering of a vehicle. It will be appreciated that the output signal can be used in such a manner in cases where a number input will not be quick and flexible enough.

Moreover, optionally, when controlling the quantity of the at least one analogue parameter, the method includes setting the quantity of the at least one analogue parameter to a discrete value from amongst a plurality of discrete values available for the at least one analogue parameter. As an example, in a case where the at least one analogue parameter is a volume of sound, the volume of sound can be set at discrete values, for example, ranging from ‘0’ (zero) to ‘100’.

Moreover, optionally, when controlling the quantity of the at least one analogue parameter, the method includes displaying a UI element representing a quantity control on a feedback device in a manner that the UI element overlaps or blends over a view of a hand of the user, thereby facilitating Augmented Reality (AR). This potentially allows the user to control the UI element with ease.

The aforementioned method is particularly suitable for use with smart glasses, OHMD's, video see-though HMD's, Near-Eye Displays (NED's), retinal projectors, retinal implants and the like. As an example, a virtual slider, a seek bar, a knob or a progress bar can be overlaid on an OHMD or a video see-through HMD, as will be elucidated later in conjunction with FIG. 8.

Additionally or alternatively, optionally, when controlling the quantity of the at least one analogue parameter, the method includes rendering on the feedback device a value of the quantity of the at least one analogue parameter. Optionally, in this regard, the method includes rendering the value of the quantity in real time, namely as the quantity is being changed. As an example, a numerical value of the quantity can be displayed on the feedback device. As another example, the change in the quantity can be notified by increasing an intensity of vibration of a haptic output.

According to an embodiment of the present disclosure, the method includes processing the output signal to provide a feedback to the user. The feedback can be in a form of a visual feedback, an audio feedback, a haptic feedback, or a combination thereof.

Optionally, the feedback is provided to the user prior to controlling the quantity of the at least one analogue parameter.

Moreover, according to an embodiment of the present disclosure, the method includes rendering on the feedback device a plurality of user-selectable objects corresponding to a plurality of mutually different analogue parameters, and detecting a user's selection of the at least one analogue parameter to be controlled. As an example, the plurality of user-selectable objects may correspond to different input options of an audio amplifier, for example, such as “TAPE”, “CD”, “TUNER”, and the like. An example of how the user-selectable objects can be rendered and selected has been illustrated in conjunction with FIG. 6 as explained in more detail below.

Optionally, the user-selectable objects are in a form of icons. Optionally, the user selects a particular icon by making a predefined hand gesture over or under that particular icon. In one example implementation, the predefined hand gesture can be a hovering gesture, wherein the user makes the hovering gesture by stopping a finger over or under that particular icon for a predefined time period. In another example implementation, the predefined hand gesture can be a grabbing gesture, wherein the user makes the grabbing gesture by positioning his/her open hand over or under the particular icon, and then closing his/her first so as to grab that particular icon.

Optionally, the user-selectable objects are in a form of switches. Optionally, the user switches between “on” and “off” states of a particular switch by making a predefined hand gesture. In one example implementation, the predefined hand gesture can be a clicking gesture, wherein the user makes the clicking gesture by positioning a finger over or under the particular switch and moving the finger towards or away from the imaging device to click on that particular switch.

According to an embodiment of the present disclosure, the feedback device is implemented by way of a see-through display. Optionally, in this regard, the feedback device is used for facilitating Augmented Reality (AR).

Optionally, the feedback device is associated with a wearable technology, for example, such as a smart glass, an OHMD, a video see-through HMD, an NED, a retinal projector and the like. An example of the OHMD is Google Glass; “Google” is a registered trademark. An example of the video see-through HMD is Oculus Rift and Samsung Gear VR; “Oculus” and “Samsung” are registered trademarks.

Other examples of the feedback device include, but are not limited to, projection displays, semi-transparent mirrors, monitors, and touch screens.

For illustration purposes only, there will now be considered an example implementation of the aforementioned method pursuant to embodiments of the present disclosure.

An example operation loop includes the following steps:

Step 1: A computing device waits in a low-power hibernating or sleep mode of operation.
Step 2: The computing device switches from the low-power hibernating or sleep mode of operation to a full-power mode of operation when a predefined activation gesture is identified.
The step 2 includes:
Step 2.1: The computing device receives a sequence of still images from an imaging device.
Step 2.2: The computing device analyses the sequence of still images to identify at least one hand gesture made by a user.
Step 2.3: The computing device determines whether or not the at least one hand gesture includes the predefined activation gesture.
Step 2.4: If the at least one hand gesture includes the predefined activation gesture, the computing device switches from the low-power hibernating or sleep mode of operation to the full-power mode of operation.
Step 3 (Optional): The computing device signals to the user that the predefined activation gesture is identified and requests the user to make subsequent gestures.
Step 4: The computing device checks for an access to various analogue parameters that can be controlled.
Step 5: The computing device renders user-selectable objects on a feedback device, in order to enable the user to select an analogue parameter to be controlled.
Step 6: Based upon user's selection of a user-selectable object, the computing device displays a UI element representing a quantity control for a selected analogue parameter on the feedback device in a manner that the UI element overlaps or blends over a view of a first hand of the user. Optionally, the UI element is overlapped or blended over a view of a palm of the first hand of the user.
Step 7: The computing device detects a position and a direction of motion of a finger of a second hand of the user relative to the first hand. Accordingly, the computing device changes a quantity of the analogue parameter.
Step 8: The computing device communicates the quantity of the analogue parameter to a remote device.
Step 9: The computing device switches from the full-power mode of operation to the low-power hibernating or sleep mode of operation. Optionally, the computing device switches to the low-power hibernating or sleep mode of operation, when it does not detect any occurrence of a predefined hand gesture within a predefined waiting period.
Alternatively, optionally, the computing device switches to the low-power hibernating or sleep mode of operation, when a predefined deactivation gesture is identified. Optionally, in this regard, the step 9 includes:
Step 9.1: The computing device receives a sequence of still images from the imaging device.
Step 9.2: The computing device analyses the sequence of still images to identify at least one hand gesture made by the user.
Step 9.3: The computing device determines whether or not the at least one hand gesture includes the predefined deactivation gesture.
Step 9.4: If the at least one hand gesture includes the predefined deactivation gesture, the computing device switches from the full-power mode of operation to the low-power hibernating or sleep mode of operation.
Step 10 (Optional): The computing device signals to the user that the predefined deactivation gesture is identified.

It will be appreciated that the aforementioned method can be implemented in other alternative ways. As an example, in an alternative implementation of the aforementioned method, the step 6 can be replaced with another step in which a value of the quantity of the selected analogue parameter is rendered on the feedback device. As an example, a numerical value of the quantity can be displayed on the feedback device. As another example, the change in the quantity can be notified by increasing an intensity of vibration of a haptic output.

In a third aspect, embodiments of the present disclosure provide a computer program product comprising a non-transitory machine-readable data storage medium having stored thereon program instructions that, when accessed by a processing device, cause the processing device to:

analyse a sequence of still images to identify at least one hand gesture made by a user;
determine whether or not the at least one hand gesture includes at least one predefined hand gesture;
identify an output signal corresponding to the at least one hand gesture, when the at least one hand gesture includes at least one predefined hand gesture; and
use the output signal to control a quantity of at least one analogue parameter.

According to an embodiment of the present disclosure, the at least one analogue parameter is related to a computing device of which the processing device is a part. According to another embodiment of the present disclosure, the at least one analogue parameter is related to a remote device; in this embodiment, the quantity of the at least one analogue parameter is remotely communicated to the remote device.

Examples of such analogue parameters include, but are not limited to, a volume of sound of a television, a direction of movement of a robot, an intensity of light emitted by a light source, a speed of a fan, a temperature of a heating or cooling appliance, a direction of movement of a pointer object, a brightness of a display, a zooming-in or zooming-out of an image, a cropping of an image, and a steering of a vehicle. It will be appreciated that the output signal can be used in such a manner in cases where a number input will not be quick and flexible enough.

Moreover, optionally, when controlling the quantity of the at least one analogue parameter, the processing device is configured to display a user interface (UI) element representing a quantity control on a feedback device in a manner that the UI element overlaps or blends over a view of a hand of the user. This enables the processing device to facilitate Augmented Reality (AR). This potentially allows the user to control the UI element with ease. As an example, a virtual slider, a seek bar, a knob or a progress bar can be overlaid on an OHMD or a video see-through HMD, as will be elucidated later in conjunction with FIG. 8.

Additionally or alternatively, optionally, when controlling the quantity of the at least one analogue parameter, the processing device is configured to render on the feedback device a value of the quantity of the at least one analogue parameter. Optionally, in this regard, the processing device is configured to render the value of the quantity in real time, namely as the quantity is being changed. As an example, a numerical value of the quantity can be displayed on the feedback device. As another example, the change in the quantity can be notified by increasing an intensity of vibration of a haptic output.

### DETAILED DESCRIPTION OF DRAWINGS

Referring now to the drawings, particularly by their reference numbers, FIG. 1 is a schematic illustration of a system 100 for providing a hand-gesture-based human-to-device interface, in accordance with an embodiment of the present disclosure.

The system 100 includes an imaging device 102, a computing device 104 and a feedback device 106. The feedback device 106 includes a data storage 108.

FIG. 1 is merely an example, which should not unduly limit the scope of the claims herein. It is to be understood that the specific designation for the system 100 is provided as an example and is not to be construed as limiting the system 100 to specific numbers or types of imaging devices, computing devices and feedback devices. A person skilled in the art will recognize many variations, alternatives, and modifications of embodiments of the present disclosure.

FIG. 2 is a schematic illustration of a head-mounted device 202 by way of which a system for providing a hand-gesture-based human-to-device interface is implemented, in accordance with an embodiment of the present disclosure.

The head-mounted device 202 includes imaging devices 204a and 204b. The head-mounted device 202 also includes a feedback device that is implemented by way of a see-through display. With reference to FIG. 2, the see-through display includes two transparent or semi-transparent screens 206a and 206b.

Each of the screens 206a and 206b has a reflective surface facing the user that is used to reflect an image of a UI element towards the user's eyes in a manner that the UI element overlaps or blends over a real view of the user's hand. In this manner, the head-mounted device 202 facilitates augmented reality.

FIG. 2 is merely an example, which should not unduly limit the scope of the claims herein. A person skilled in the art will recognize many variations, alternatives, and modifications of embodiments of the present disclosure.

FIG. 3 is a schematic illustration of various components of a computing device 300, in accordance with an embodiment of the present disclosure. The computing device 300 includes, but is not limited to, a memory 302, a computing hardware such as a processor 304, a data storage 306, a communication interface 308, and a power source 310.

FIG. 3 is merely an example, which should not unduly limit the scope of the claims herein. It is to be understood that the specific designation for the computing device 300 is provided as an example and is not to be construed as limiting the computing device 300 to specific numbers, types, or arrangements of modules and/or components of the computing device 300. A person skilled in the art will recognize many variations, alternatives, and modifications of embodiments of the present disclosure. For example, the computing device 300 could be implemented as the computing device 104, and vice versa.

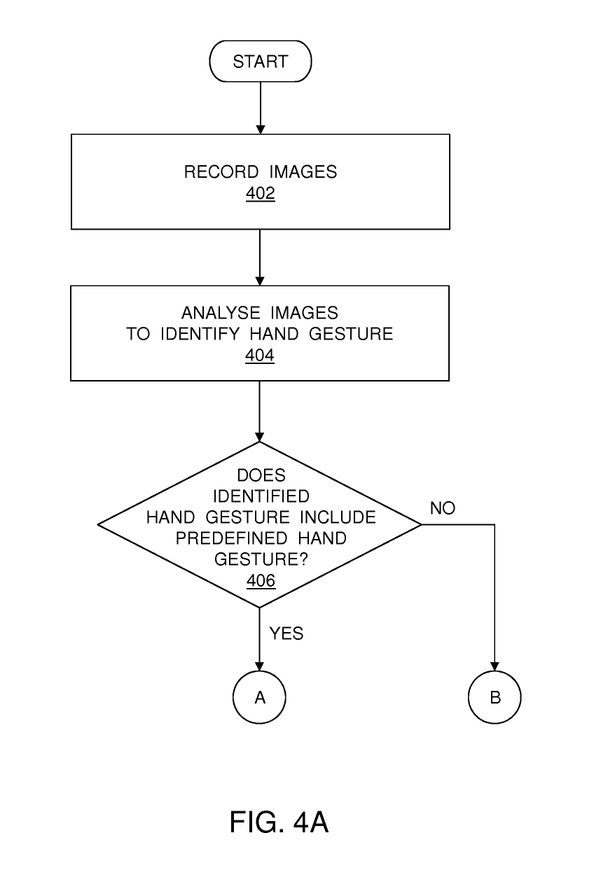

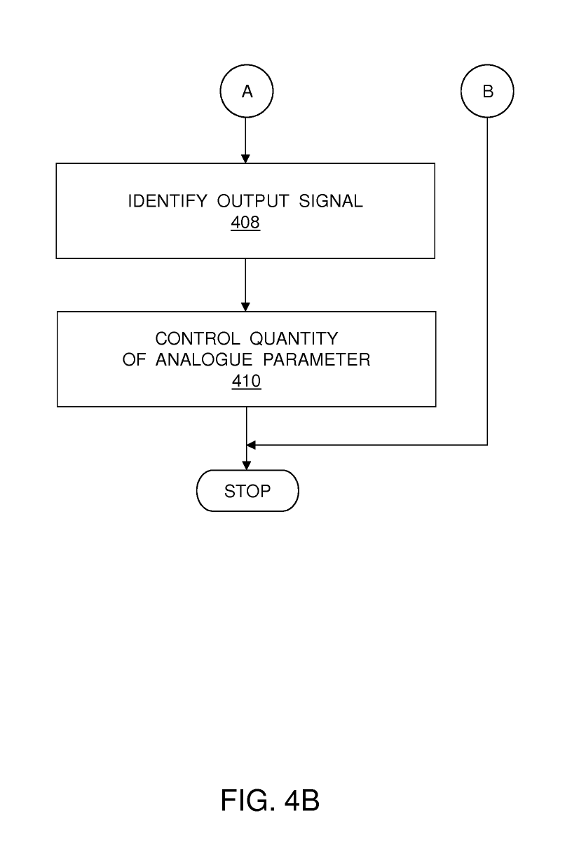

FIGS. 4A and 4B collectively are an illustration of steps of a method for providing a hand-gesture-based human-to-device interface, in accordance with an embodiment of the present disclosure. The method is depicted as a collection of steps in a logical flow diagram, which represents a sequence of steps that can be implemented in hardware, software, or a combination thereof.

At a step 402, a sequence of still images is recorded.

At a step 404, the sequence of still images is analysed to identify at least one hand gesture made by a user.

Next, at a step 406, it is determined whether or not the at least one hand gesture includes at least one predefined hand gesture. If it is found that the at least one hand gesture includes at least one predefined hand gesture, a step 408 is performed. Otherwise, if it is found that the at least one hand gesture does not include any predefined hand gesture, the processing stops.

At the step 408, an output signal corresponding to the at least one hand gesture is identified.

At the step 410, the output signal is used to control a quantity of at least one analogue parameter.

The steps 402 to 410 are only illustrative and other alternatives can also be provided where one or more steps are added, one or more steps are removed, or one or more steps are provided in a different sequence without departing from the scope of the claims herein.

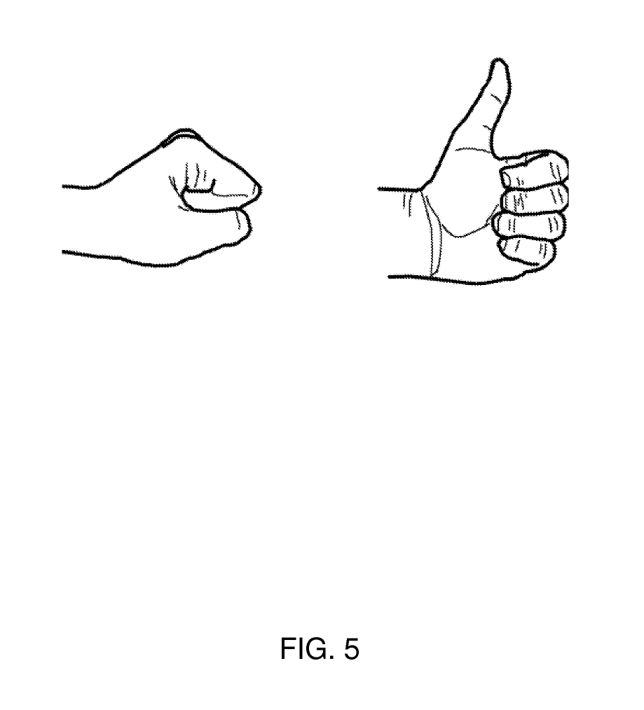

FIG. 5 is a schematic illustration of example gestures, in accordance with an embodiment of the present disclosure.

In FIG. 5, there is shown a closed first gesture of a user on a left side, and a thumbs-up gesture of the user on a right side.

When a closed first is viewed from a side of a thumb of the user, there is a spot at a centre of the closed first that can be recognized as a point by humans. Optionally, this spot is used as a tracker control, for example, corresponding to a computer mouse or other pointer objects.

Moreover, optionally, the thumbs-up gesture is used as an activation gesture.

FIG. 6 is a schematic illustration of an example hand-gesture-based human-to-device interface provided by a system pursuant to embodiments of the present disclosure.

In FIG. 6, there are shown four user-selectable objects that are rendered on a feedback device. Optionally, these user-selectable objects correspond to different analogue parameters.

The system allows the user to select one of the four user-selectable objects to initiate controlling a quantity of an analogue parameter selected by the user.

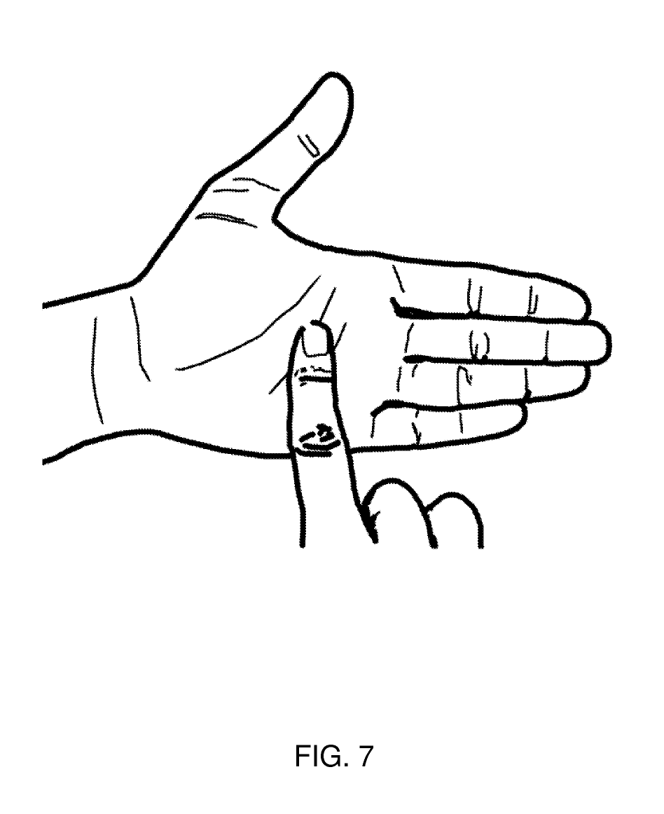

FIG. 7 is a schematic illustration of an example gesture, in accordance with an embodiment of the present disclosure.

In FIG. 7, there is shown an open palm of a first hand of a user, and an index finger of a second hand of the user over the open palm. Optionally, in the example gesture, the user moves the index finger of the second hand over the open palm, for example, in a form of a virtual slider moving over a surface of the open palm.

FIG. 8 is a schematic illustration of how a UI element is overlapped or blended over a real view of a hand of a user, in accordance with an embodiment of the present disclosure.

With reference to FIG. 8, the UI element is a virtual slider, a seek bar or a progress bar that is overlapped or blended over the real view of the hand of the user, thereby facilitating augmented reality.

In some examples, the UI element enables the user to control a quantity of an analogue parameter. In such a case, a displayed percentage value corresponds to the quantity of the analogue parameter.

In other examples, the UI element enables the user to perform a task. In such a case, the displayed percentage value corresponds to a percentage of completion of the task.

FIGS. 5 to 8 are merely examples, which should not unduly limit the scope of the claims herein. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for providing a hand-gesture-based human-to-device interface, the system comprising:
an imaging device configured to record a sequence of still images; and
a computing device coupled in communication with the imaging device, wherein the computing device comprises:
a processor; and
a memory coupled to the processor,
wherein the processor is configured to:
(a) analyse the sequence of still images to identify at least one hand gesture made by a user;
(b) determine whether or not the at least one hand gesture includes at least one predefined hand gesture;
(c) identify an output signal corresponding to the at least one hand gesture, when the at least one hand gesture includes at least one predefined hand gesture; and
(d) use the output signal to control a quantity of at least one analogue parameter.

2. The system according to claim 1, wherein the system further includes a feedback device coupled in communication with the computing device, wherein the feedback device is configured to receive the output signal from the computing device, and to process the output signal to provide a feedback to the user.

3. The system according to claim 2, wherein the feedback device is implemented by way of a see-through display to facilitate augmented reality.

4. The system according to claim 2 or 3, wherein the feedback device is associated with a wearable technology.

5. The system according to claim 1, wherein the at least one analogue parameter is related to a remote device.

6. The system according to claim 1, wherein when controlling the quantity of the at least one analogue parameter at (d), the processor is configured to display a user interface element representing a quantity control on a feedback device in a manner that the user interface element overlaps or blends over a view of a hand of the user.

7. The system according to claim 1, wherein when controlling the quantity of the at least one analogue parameter at (d), the processor is configured to render on a feedback device a value of the quantity of the at least one analogue parameter in real time.

8. The system according to claim 1, wherein the processor is configured to:
render on a feedback device a plurality of user-selectable objects corresponding to a plurality of mutually different analogue parameters; and
detect a user's selection of the at least one analogue parameter to be controlled.

9. The system according to claim 1, wherein the computing device includes a data storage for storing a plurality of predefined hand gestures and their corresponding output signals, and wherein when determining at (b), the processor is configured to lookup for the at least one hand gesture in the plurality of predefined hand gestures stored in the data storage.

10. The system according to claim 1, wherein the processor is configured to define mutually different combinations and/or sequences of simple hand gestures as mutually different hand gestures, wherein the mutually different combinations and/or sequences of simple hand gestures are performed within a predefined time period.

11. The system according to claim 1, wherein the processor is configured to switch between a low-power hibernating or sleep mode of operation and a full-power mode of operation in response to an action triggered by the output signal.

12. A method for providing a hand-gesture-based human-to-device interface, the method comprising:
recording a sequence of still images;
analysing the sequence of still images to identify at least one hand gesture made by a user;
determining whether or not the at least one hand gesture includes at least one predefined hand gesture;
identifying an output signal corresponding to the at least one hand gesture, when the at least one hand gesture includes at least one predefined hand gesture; and
using the output signal to control a quantity of at least one analogue parameter.

13. The method according to claim 12, wherein when controlling the quantity of the at least one analogue parameter, the method includes displaying a user interface element representing a quantity control on a feedback device in a manner that the user interface element overlaps or blends over a view of a hand of the user.

14. The method according to claim 12, wherein when controlling the quantity of the at least one analogue parameter, the method includes rendering on a feedback device a value of the quantity of the at least one analogue parameter in real time.

15. The method according to claim 12, wherein the method includes:
rendering on a feedback device a plurality of user-selectable objects corresponding to a plurality of mutually different analogue parameters; and
detecting a user's selection of the at least one analogue parameter to be controlled.

16. The method according to any one of claim 12, wherein the method includes defining mutually different combinations and/or sequences of simple hand gestures as mutually different hand gestures, wherein the mutually different combinations and/or sequences of simple hand gestures are performed within a predefined time period.

17. The method according to any one of claim 12, wherein the method includes switching between a low-power hibernating or sleep mode of operation and a full-power mode of operation in response to an action triggered by the output signal.

18. A computer program product comprising a non-transitory machine-readable data storage medium having stored thereon program instructions that, when accessed by a processing device, cause the processing device to:
analyse a sequence of still images to identify at least one hand gesture made by a user;
determine whether or not the at least one hand gesture includes at least one predefined hand gesture;
identify an output signal corresponding to the at least one hand gesture, when the at least one hand gesture includes at least one predefined hand gesture; and
use the output signal to control a quantity of at least one analogue parameter.
